(19) United States
(12) Patent Application Publication
(10) Pub. No.: US 2005/0065774 A1
(43) Pub. Date: Mar. 24, 2005

(54) Method of self enhancement of search results through analysis of system logs

(75) Inventors: Yurdaer Nezihi Doganata, Chestnut Ridge, NY (US); Youssef Drissi, Ossining, NY (US); Tong-Haing Fin, Harrison, NY (US); Kozakov Lev, Stamford, CT (US); Moon Ju Kim, Wappingers falls, NY (US); Juan Leon Rodriguez, Danbury, CT (US)

Correspondence Address: James R. Murray, 69 South Gate Drive, Poughkeepsie, NY, 12601, US

(73) Assignee: International Business Machines Corporation, Armonk, NY (US)

(21) Appl. No.: 10/664,450

(22) Filed: Sep. 20, 2003

(51) Int. Cl. G06F 17/28

(52) U.S. Cl. 704/7

(57) ABSTRACT

An automatic search index/meta data self-enhancement system includes a search system log analyzer, which periodically looks through the search system log, of a database, for search queries that did not bring satisfactory results; a search query analyzer which applies query enhancement techniques to the unsatisfactory queries by using glossary terms, synonyms, known typos, translated words, etc. to enhance the queries and categorize them; a relevant document finder which, based on the enhanced query terms and their categorization and subject, uncovers documents that were not previously found and links the documents to the query terms in the search index; and a search index/meta data enhancer, that enhances the meta/data of the documents based on the enhanced query terms in the search index, to reflect these new keywords to allow documents turned up by the enhanced query to be returned when similar future searches are entered by users.

### RELATED APPLICATIONS

The contents of the following listed applications are hereby incorporated by reference:

(1) U.S. patent application Ser. No. 10/157,243, filed on May 30, 2002 and entitled “Method and Apparatus for Providing Multiple Views of Virtual Documents.”

(2) U.S. patent application Ser. No. 10/159,373, filed on Jun. 3, 2002 and entitled “A System and Method for Generating and Retrieving Different Document Layouts from a Given Content.”

(3) U.S. patent application Ser. No. 10/180,195, filed on Jun. 27, 2002 and entitled “Retrieving Matching Documents by Queries in Any National Language.”

(4) U.S. patent application, (YOR920020141), filed on Jul. 23, 2002 and entitled “Method of Search Optimization Based on Generation of Context Focused Queries.”

(5) U.S. patent application Ser. No. 10/209,619 filed on Jul. 31, 2002 and entitled “A Method of Query Routing Optimization.”

(6) U.S. patent application Ser. No. 10/066,346 filed on Feb. 1, 2002 and entitled “Method and System for Searching a Multi-Lingual Database.”

(7) U.S. patent application Ser. No. 10/229,552 filed on Aug. 28, 2002 and entitled “Universal Search Management Over One or More Networks.”

(8) U.S. patent application Ser. No. 10/180,195 filed on Jun. 26, 2002 and entitled “An International Information Search and Delivery System Providing Search Results Personalized to a Particular Natural Language.”

(9) U.S. patent application Ser. No. (CHA920030020US1) filed on even date herewith entitled “Method of Search Content Enhancement.”

### FIELD OF THE INVENTION

The present invention relates to performing keyword searches and obtaining search results on database networks. More particularly, it relates to the improvement of the effectiveness of searches in obtaining desired search results.

### BACKGROUND OF THE INVENTION

Internet text retrieval systems accept a statement for requested information in terms of a search query S made up of a plurality of keywords T₁, T₂, . . . Tᵢ, . . . Tₙ and return a list of documents that contain matches for the search query terms. To facilitate the performance of such searches on internet databases, search engines have been developed that provide a query interface to the information containing sources and return search results ranked sequentially on how well the listed documents match the search query. The effectiveness in obtaining desired results varies from search engine to search engine. This is particularly true in searching certain product support databases which can be heavily weighted with technical content and the queries tend to be repetitive. In such databases, information can be in a number of natural languages, both in analog and digital form, and in a number of different formats, and in multiple machine languages. The relevancy of the search results depends on many factors, one being on the specificity of the search query. If the search query was specific enough, the probability of getting relevant results is generally higher. For example, the probability of getting documents on ‘Java exception handling’ is higher for the query ‘Java exception’ than for the query ‘exception’. At the same time, some relevant documents may be excluded by a specific search query, because the query does not contain certain combinations of terms, contains superfluous terms or address the same subject matter using different words. For instance, as shown in FIG. 1, if the query is ‘video player for PC’, the search engine may not be able to find and return relevant documents that are not about personal computers and/or instead of using ‘video player’ contain terms like ‘DVD driver’ or ‘multimedia software’. Approaches to broaden searches by adding synonymous search terms and disregarding bad query terms are known. However, results using these known approaches have not been entirely satisfactory in turning up relevant documents and/or require additional real time examination of database logs and/or databases.

Therefore it is an object of the present invention to provide an improvement in search engine search results.

Another object of the present invention is to broaden search results to uncover relevant documents that do not contain requested query terms.

It is further an object of the present invention to provide requested information to searchers in selected technical areas.

### BRIEF DESCRIPTION OF THE INVENTION

In accordance with the present invention, anautomatic search index/meta data self-enhancement system includes a search system log analyzer, which periodically looks through the search system log, of a database, for search queries that did not bring satisfactory results; a search query analyzer which applies query enhancement techniques to the unsatisfactory queries by using glossary terms, synonyms, known typos, translated words, etc. to enhance the queries and categorize them; a relevant document finder which, based on the enhanced query terms and their categorization and subject, uncovers documents that were not previously found and links the documents to the query terms in the search index; and a search index/meta data enhancer, that enhances the meta/data of the documents based on the enhanced query terms in the search index, to reflect these new keywords to allow documents turned up by the enhanced query to be returned when similar future searches are entered by users.

Since the above analysis arrangement is performed on on all customer queries, the search system enhancements have a direct effect on customer satisfaction. Further because the query log analysis and relevant document identification is performed off-line, response time to customer queries is not affected. In addition, with the search enhancements of the present invention the search system learns from user iterations.

### DESCRIPTION OF THE DRAWINGS

FIG. 1 is a schematic diagram illustrating limitations in a prior art search process;

FIG. 2 is a schematic diagram for system organization of an on-line area network;

FIG. 3 is a schematic diagram of a private network incorporating the present invention and connected to the network shown in FIG. 2;

FIG. 4 is a schematic diagram showing the arrangement of a search system of the present invention;

FIG. 5 is a schematic diagram showing details of the modules in FIG. 4;

FIG. 6 is a schematic diagram showing the storage of document listings associated with search terms; and

FIG. 7 is a schematic flow diagram showing the the operation of the search systems of FIGS. 4, 5 and 6.

### DETAILED DESCRIPTION OF THE INVENTION

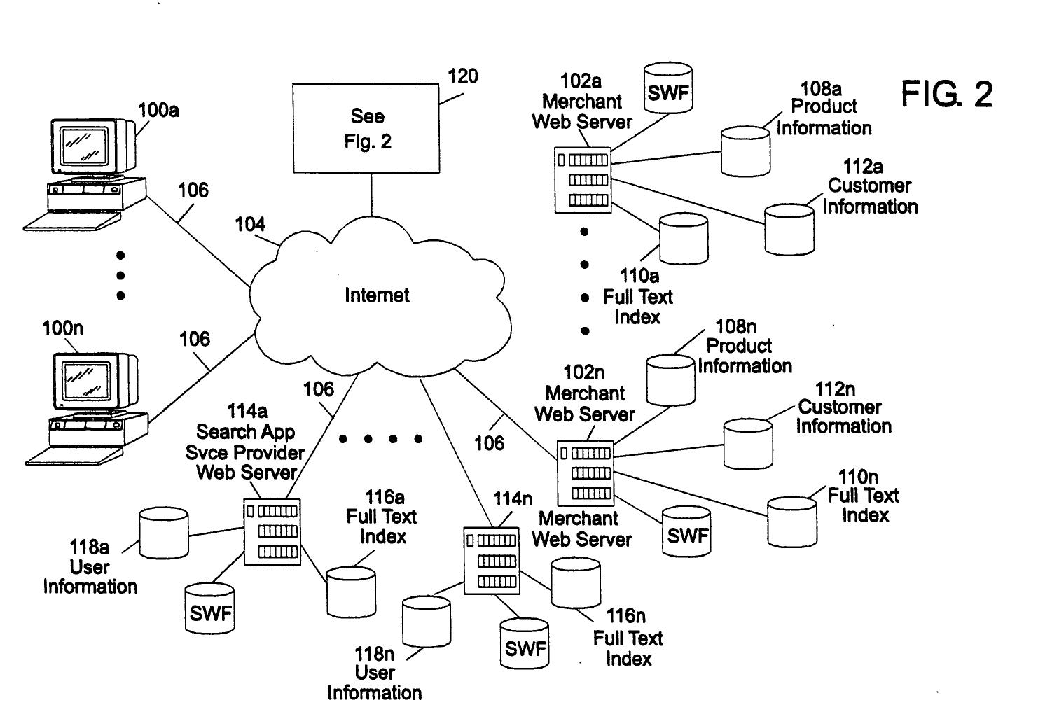

Referring now to FIG. 2, communication between a plurality of user computers 100a to 100n and a plurality of information servers 102a to 102n is accomplished via an on-line service through a wide area network such as the Internet 104 that includes network node servers. The network node servers manage network traffic such as the communications between any given user's computer and an information server.

The computers 100 are equipped with communications software, including a WWW browser such as the Netscape browser of Netscape Communications Corporation, that allows a shopper to connect and use on-line shopping services via the Internet. The software on a user's computer 100 manages the display of information received from the servers to the user and communicates the user's actions back to the appropriate information servers 102 so that additional display information may be presented to the user or the information acted on. The connections 106 to the network nodes of the Internet may be established via a modem or other means such as a cable connection.

The servers illustrated in FIG. 2, and discussed hereafter, are those of merchants which, for a fee provide products, services and information over the Internet. While the following discussion is directed at communication between shoppers and such merchants over the Internet, it is generally applicable to any information seeker and any information provider on a network. (For instance, the information provider can be a library such as a University library, a public library or the Library of Congress or other type of information providers.) Information regarding a merchant and the merchant's products is stored in a shopping database 108 to which the merchants servers 102 have access. This may be the merchants own database or a database of a supplier of the merchant. All product information accessible by the merchant servers that is publishable as web pages is indexed and a full-text index database 110 which records the number of occurrences of each of the words and their use in the location. In addition to the servers of individual merchants, and other information providers, there are the servers 114a to 114 of plurality of search service providers, such as Google of Google, Inc., which providers maintain full text indexes 116 of the products of the individual merchants 102a to 102n obtained by interrogating the product information databases 108 of the individual merchants. Some of these search service providers, like Google, are general purpose search providers while others are topic specific search providers.

The merchants and the search application service providers each may maintain a database of information about shoppers and their buying habits to customize on-line shopping for the shopper. Operations to accomplish a customized electronic shopping environment for the shopper include accumulating data regarding the shopper's preferences. Data relating to the electronic shopping options, such as specific sites and specific products selected by the shopper, entry and exit times for the sites, number of visits to the sites, etc., are recorded and processed by each merchant to create a shopping profile for the shopper. Raw data may then be processed to create a preference profile for the shopper. The profile may also include personal data or characteristics (e.g. age, occupation, address, hobbies) regarding the shopper as provided by the shopper when subscribing to the service or obtained from other sources. Profile data can help in discerning the meaning of words used in a keyword query. For instance, a keyword in the query of a medical doctor could have an entirely different meaning to the use of the same keyword presented by a civil engineer. The data accumulation on the shoppers are placed in the shoppers profile database 112 or 118 of each of the merchants. Each individual shopper's profile in the databases of the merchants and the search application service providers can differ from one to another based on the particular merchant's or service providers experience with the shopper and their profiling software. Data collection may continue during searches made by the shopper so that up-to-date profile data for the shopper is obtained and used.

With information regarding the shopper involved in the shopping transaction, the merchant is able to meet the needs of the shopper, and the shopper is presented with the opportunity to view and purchase that merchandise that is most likely to be of interest since the merchant's products and services are directed toward those shoppers who have, either directly or indirectly, expressed an interest in them.

When the search characteristics in the form for key words are entered by the shopper into the space provided on the default or home page of his/her browser, the search engine of the merchant web server 102 does a search of the accessed full text index database 110 or 118 using the key words and gets a list of documents describing those products and services that contain matches to the key words. This list of documents contain basic test ranking Tf (including the number of hits, their location, etc. which are used to order the list of documents) with documents with higher scores at the top. This list is then sent to a ranking module which will apply a ranking algorithm, such as the one described in the article entitled “The Anatomy of a Large-Scale Hypertextual Web Search Engine” by Sergey Brin and Lawrence Page of the Computer Science Department, Stanford University, Stanford Calif. 94305 (which article is hereby incorporated by reference) to rank the list of documents using the text factors and other rank factors, such as link analysis, popularity, the user's preferences from the users profile, and may also introduce factors reflecting the information, providers biases and interests. A reordered list of documents based on the ranking algorithm is then provided to the user.

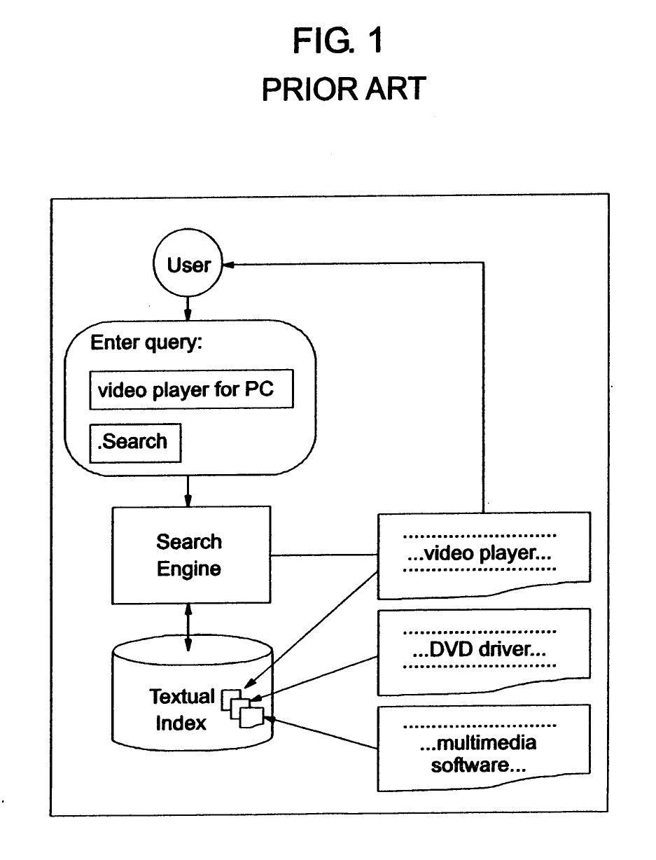

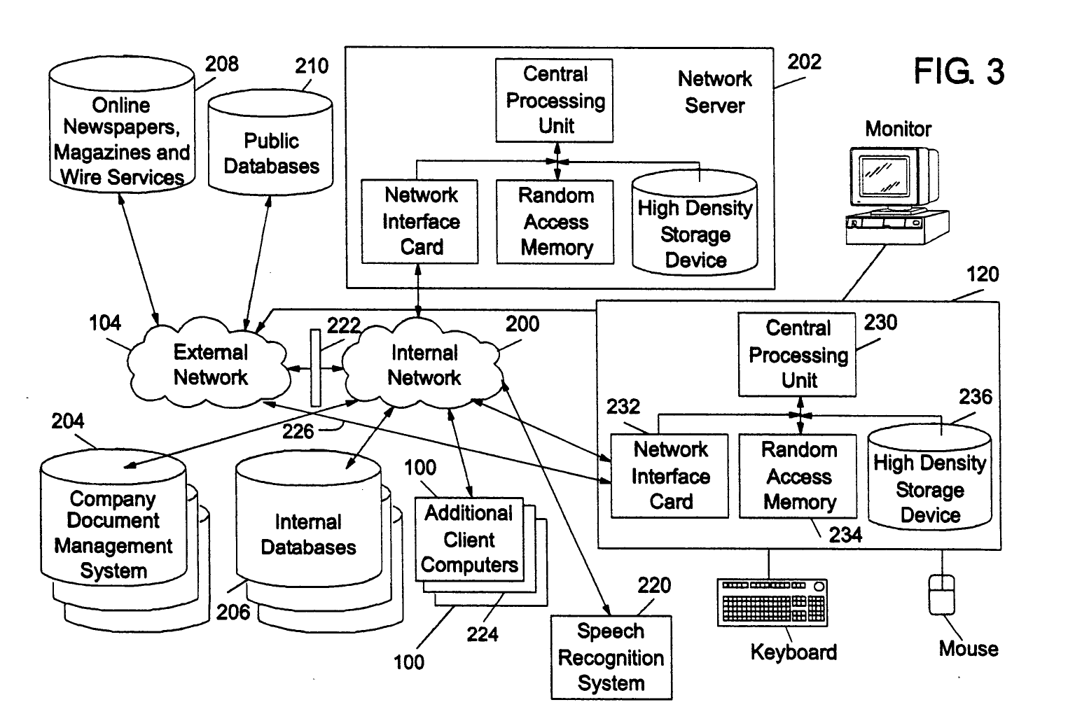

FIG. 3 shows how a multi-language internet search management server 120 can be used as one of the merchants web server 120 obtain information from the merchant and supply it to a user. As shown in FIG. 2, the search management server 120 is connected in a private intranet network 200 with a server 202 and a number of computers 100, such as those described in FIG. 1, so that the computers 100 can obtain information stored in the internal sources of the private intranet. The intranet 200 is provided with public internet access capability which provides access to services on the public internet 104. A “firewall” 222 separates the public internet 104 from the private intranet 200 allowing only those with the proper ID and password to enter the intranet 200 from the public internet 104. Internal sources of the intranet 200 are company document management systems 204, and internal databases 206. Also, intranet 200 is provided with a speech recognition system 220 capable of responding to compressed digitized data of voice commands and voice dictation provided by the client computers 100 either from an individual computer 100 or a client's network of such computers.

In the above mentioned U.S. application Ser. 10/180,195, the search management server 120 contains an integrated search management system which receives queries and information from search engines both in the intranet and internet and accesses information sources other than those that are in the intranet and internet through the computers 100. For example, voice messages transmitted to computer 224 and connected to text by a speech recognition system 220 can be stored in the integrated search management system. The integrated management server contains a central processing unit 230, network interfaces 232 and sufficient random access memory 234 and high density storage 236 to perform its functions. In addition to its connection to the intranet, the search management system contains a direct link 226 to the internet to enable access by customers of the merchant.

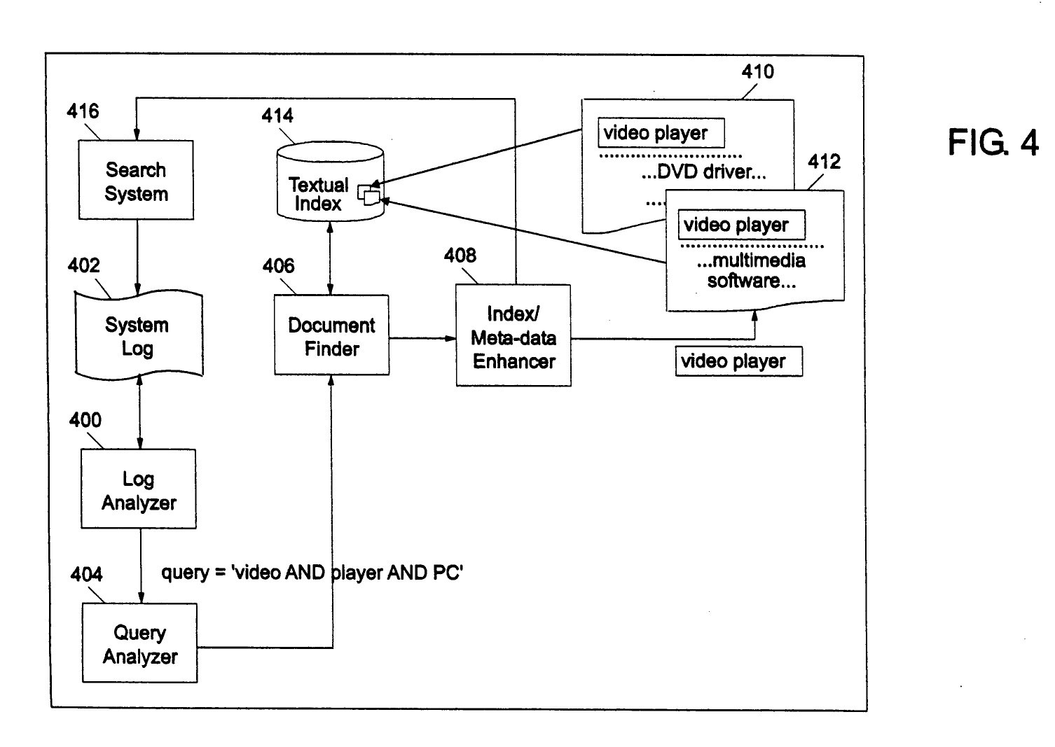

Recently, the number of search systems and search engines types grew rapidly. For each given domain, a diversity of specialized search engines could be presented as potential candidates offering different features and performances. While these specialized search systems are invaluable in restricting the scope of searches to pertinent classes, as pointed out above, relevant documents are missed. This is particularly troublesome in technically oriented databases where unsuccessful search queries resemble one another resulting in dissatisfaction. This invention provides a solution to this problem through a search enhancement that involves examination of previous search results received by customers in response to unsuccessful queries. Unsuccessful queries may be ones that return too few references (say less than 5) or ones that have elicited customer complaints. As shown in FIG. 4, the automatic search index/meta data self-enhancement system has a number of different modules. A search system log analyer 400 periodically looks through the search system log 402, and identifies search queries that did not bring satisfactory results. For instance, the query video and player and PC of FIG. 1 provides limited results missing pertinent references dealing with DVD drivers and multi-media software. A search query analyzer 404 applies known query enhancement techniques to the unsatisfactory queries by using glossary terms, synonyms, known typos, translated words, etc. of the query terms automatically categorizing and assign the query to one or more subject areas. The results, provided by the query analyzer, are provided to a relevant document finder 406 which, based on the enhanced queries and their categorization, detects documents to the original query terms in the search index. A search index/meta data enhancer 408 enhances the meta/data of the documents obtained using the enhanced query terms (‘video player’ is added to documents 410 and 412 in the text index not turned up using the customer's original search terms) and the system log is updated by the system 416 to contain new keywords to allow for documents containing those terms to be returned when similar future searches are entered.

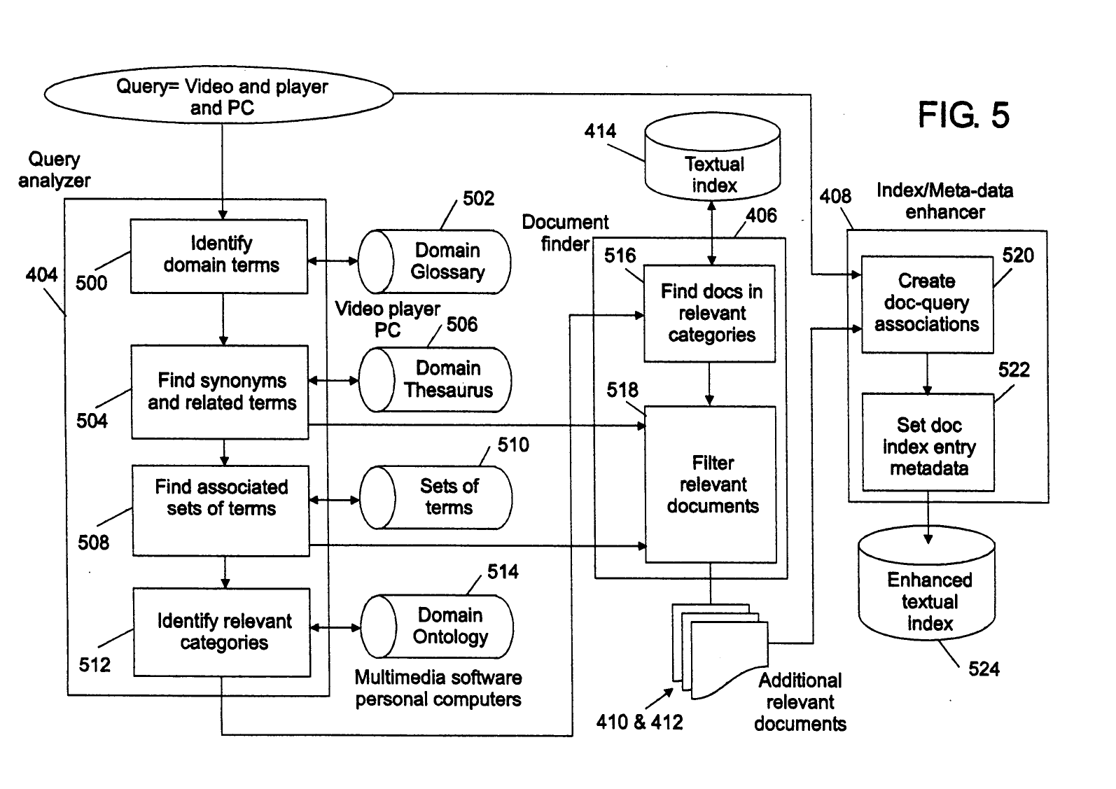

FIG. 5 illustrates one preferred method of implementing three modules shown in FIG. 4: Query Analyzer module 404, the Document Finder module 406, and the Index/Meta-data Enhancer module 408.

The Query Analyzer module 404 includes of the following sub-modules:
a sub-module 500 that identifies domain specific terms in a given query, using domain specific glossary 502.
a sub-module 504 that finds synonyms and related terms for the identified terms, using domain specific thesaurus 506.
a sub-module 508 that finds other statistically close terms, using associated sets of terms.
a sub-module 512 that identifies relevant domain specific categories for the identified terms, using domain specific ontology 514.

The output of the Query Analyzer 404 is passed to the Document Finder module 406 that comprises the following sub-modules:
a sub-module 516 that finds documents in the identified categories, using the original textual index 414.
a sub-module 518 that filters the found documents to find additional relevant documents, based on the identified domain specific terms, synonyms, related terms, and statistically close terms from modules 504 and 508.

The list of additional relevant documents, created by the Document Finder 406, is passed to the Index/Meta-data Enhancer module 408 that comprises the following sub-modules:
a sub-module 520 that creates associations (links) between each found document and the given query.
a sub-module 522 that adds new doc-query links to the meta-data of the corresponding textual index entries.

The Index/Meta-data Enhancer module modifies the original Textual Index 524, creating Enhanced Textual Index that replaces the original Textual Index, and allows to find more relevant documents in response to the given query.

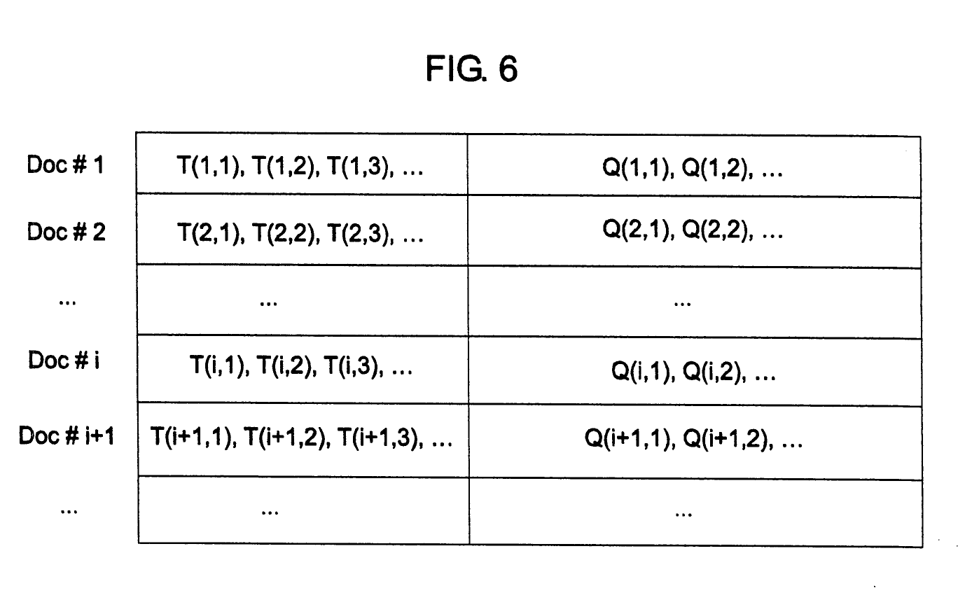

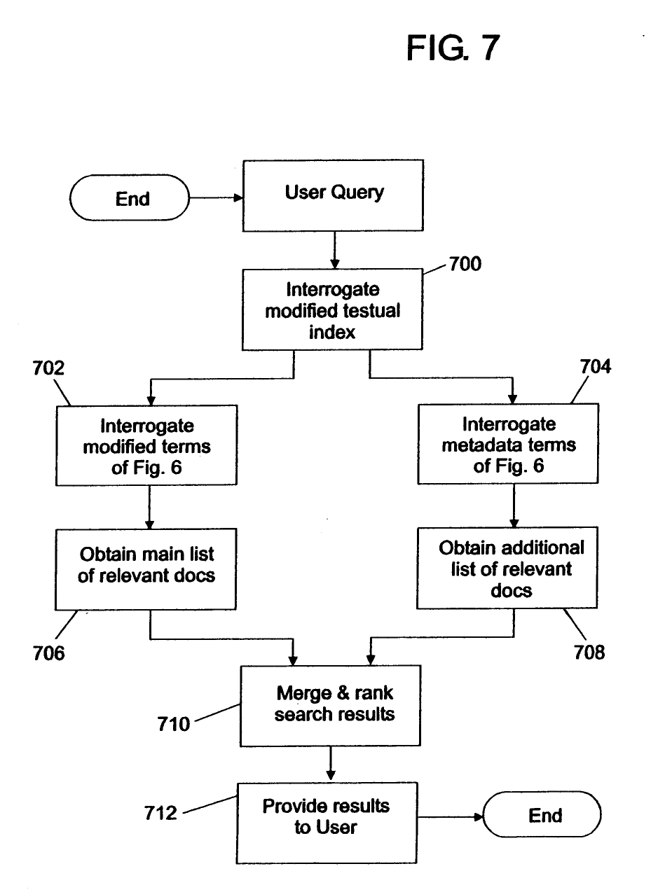

Referring now to FIG. 6, along with search query terms (1(1,1), 1(1,2) 1(1,3), . . . that are found in each document such as Doc #1, there are meta/data associated with each document that contains queries Q (1,1), Q (1,2), . . . that generated using the present invention and provided in the enhanced Textual Index. Referring now to FIG. 7, in step 700 the user query (say Q(1,1) is used to interrogate in step 700 the extended or modified texual index of each document of FIG. 6 generated off-line. The query O (1,1) interrogates both the search query terms found in each of the documents in step 702 and the meta/data search query terms in step 704 to identify relevant documents in steps 706 and 708. As a result, Doc #1 is identified as having meta/data containing the query Q(1,1). The results are then ordered in step 710 using not only original query words found in step 706 but also the modified query words obtained in step 708 and the results provided to the end user in step 712.

Above described is one embodiment of the invention. Of course a number of changes can be made. For instance the ordering of the documents on the basis of the enhanced keywords could be done in steps instead of all at once. In such a system the documents would be obtained first by the original set of keywords and selectively the alternative words would be to obtain more documents and in ordering the documents returned by the enhanced keywords. Therefore it should be understood that while only one embodiment of the invention is described, a number of modifications can be made in this embodiment without departing from the spirit and scope of the invention as defined by the attached claims.

1. An self-enhancing search system comprising:
a search system analog system that periodically looks through the search system log and identifies search queries that do not bring satisfactory results;
a search query analyzer using one or more of the glossary, synonyms, known typographical errors and translated words to provide alternative query terms;
relevant document finder based on enhanced queries including the alternative query terms to locate documents not found by the original search; and
a linking enhanced query terms with the original search terms to reflect new keywords to be searched.

2. The search system of claim 1, wherein the search queries are queries made by customers.

3. The search system of claim 2 including embedding the search query terms unsatisfied queries in the documents located by the enhanced queries.

4. The search system of claim 3 including associated enhanced queries with the unsatisfactory queries in the search system log for use with further queries.

5. The search system of claim 4 including ranking the results of searches using the enhanced queries.

6. The search system of claim 5, wherein Query Analyzer module comprises:
a sub-module that identifies domain specific terms in a given query, using domain specific glossary;
a sub-module that finds synonyms and related terms for the identified terms, using domain specific thesaurus;
a sub-module that finds other statistically close terms; and
a sub-module that identifies relevant domain specific categories for the identified terms, using domain specific ontology.

7. The search system of claim 6, wherein the Document Finder module comprises the following sub-modules:
a sub-module that finds documents in the identified categories, using the original textual index; and
a sub-module that filters the found documents to find additional relevant documents, based on the identified domain specific terms, synonyms, related terms, and statistically close terms.

8. The search system of claim 7, wherein the Index/Meta-data Enhancer module comprises the following sub-modules:
a sub-module that creates associations (links) between each found document and the given query; and
a sub-module that adds new doc-query links to the meta-data of the corresponding textual index entries.

9. A computer program on a computer useable medium for providing a self-enhancing search system comprising:
a search system analog system software module that periodically looks through the search system log and identifies search queries that do not bring satisfactory results;
a search query analyzer software module using one or more of the glossary, synonyms, known typographical errors and translated words to provide alternative query terms;
relevant document finder software module based on enhanced queries including the alternative query terms to locate documents not found by the original search; and
a linking software module enhanced query terms with the original search terms to reflect new keywords to be searched.

10. The computer program for search system of claim 9, wherein the search queries are queries made by customers.

11. The computer program for the search system of claim 10 including software for embedding the search query terms unsatisfied queries in the documents located by the enhanced queries.

12. The computer program for search system of claim 11 including software for providing associated enhanced queries with the unsatisfactory queries in the search system log for use in connection with further customer queries.

13. The computer program for the search system of claim 12 including software for ranking the results of searches in order of their per tenancy using the enhanced query terms as a ranking basis.

14. The computer program for search system of claim 13, wherein Query Analyzer module comprises:
a software sub-module that identifies domain specific terms in a given query, using domain specific glossary;
a software sub-module that finds synonyms and related terms for the identified terms, using domain specific thesaurus;
a software sub-module that finds other statistically close terms; and
a software sub-module that identifies relevant domain specific categories for the identified terms, using domain specific ontology.

15. The computer program for the search system of claim 14, wherein the Document Finder module comprises the following software sub-modules:
a software sub-module that finds documents in the identified categories, using the original textual index; and
a software sub-module that filters the found documents to find additional relevant documents, based on the identified domain specific terms, synonyms, related terms, and statistically close terms.

16. The computer program for the search system of claim 15, wherein the Index/Meta-data Enhancer module comprises the following sub-modules:
a software sub-module that creates associations (links) between each found document and the given query; and
a software sub-module that adds new doc-query links to the meta-data of the corresponding textual index entries.
